(19) United States
(12) Patent Application Publication
(10) Pub. No.: US 2022/0135033 A1
(43) Pub. Date: May 5, 2022

(54) METHOD AND DEVICE FOR AUTOMATICALLY SETTING A SPEED-CONTROL OR PROXIMITY-CONTROL SYSTEM OF A TWO-WHEELED MOTOR VEHICLE

(71) Applicant: Robert Bosch GmbH, Stuttgart (DE)

(72) Inventors: Mathieu Grelaud, Ludwigsburg (DE); Michael Schoenherr, Renningen-Malmsheim (DE)

(21) Appl. No.: 17/427,315

(22) PCT Filed: Feb. 10, 2020
(86) PCT No.: PCT/EP2020/053270

§ 371 Date: Jul. 30, 2021

(30) Foreign Application Priority Data
Apr. 25, 2019 (DE) 102019205881.7

(51) Int. Cl. B60W 30/165; B60W 50/08; B60W 40/04

(52) U.S. Cl. CPC B60W 30/165; B60W 50/082; B60W 40/04; B60W 2300/36; B60W 2554/802; B60W 2554/4026; B60W 2554/4041; B60W 2554/801; B60W 2520/10

(57) ABSTRACT

A method for automatically setting a speed-control or proximity-control system of a two-wheeled motor vehicle. In the method, it is ascertained if the two-wheeled motor vehicle is on a group ride with at least one other two-wheeled motor vehicle; and in the event of a group ride, the speed-control or proximity-control system is switched to a special operating mode.

### BACKGROUND INFORMATION

German Patent Application No. DE 10 2017 201 698 A1 describes a method for influencing a speed-control system of a two-wheeled motor vehicle, where after the rider activates the method, the speed of a second motor vehicle traveling directly ahead is ascertained and the speed of the motor vehicle traveling ahead is taken on by the motor vehicle; both increases and decreases in the speed of the motor vehicle traveling ahead being taken on.

### SUMMARY

The present invention relates to a method for automatically setting a speed-control or proximity-control system of a two-wheeled motor vehicle. In accordance with an example embodiment of the present invention, in the method
it is ascertained if the two-wheeled motor vehicle is on a group ride with at least one other two-wheeled motor vehicle; and
in the event of a group ride, the speed-control or proximity-control system is switched to a special operating mode.

In one advantageous refinement of the present invention, a group ride is then detected as present,
if the presence of a vehicle traveling ahead is ascertained;
if the vehicle traveling ahead is a second two-wheeled motor vehicle; and
if the second two-wheeled motor vehicle is offset laterally from the two-wheeled motor vehicle, the offset exceeding a predefined threshold value.

The risk of a collision and/or being rear-ended is also reduced by the required presence of a lateral offset.

In one advantageous refinement of the present invention, the lateral offset may be both an offset in the direction of the right edge of the roadway and an offset in the direction of the left edge of the roadway.

In one advantageous refinement of the present invention, the two-wheeled motor vehicle includes a video sensor system, and that the determination as to whether the vehicle traveling ahead is a second two-wheeled motor vehicle is made by evaluating the output signals of the video sensor system.

In one advantageous refinement of the present invention, in the special operating mode, a shorter distance from a second two-wheeled motor vehicle is allowed.

In one advantageous refinement of the present invention, the two-wheeled motor vehicle is a motorcycle.

In addition, the present invention includes an apparatus having devices, which are configured to implement the methods according to the present invention. This is, in particular, a control unit, in which the program code for implementing the methods of the present invention is stored.

### BRIEF DESCRIPTION OF THE DRAWINGS

FIGS. 1a-1d show different scenarios in the case of a two-wheeled motor vehicle traveling ahead.

FIGS. 2a-2c show different scenarios in the case of a four-wheeled motor vehicle traveling ahead.

### DETAILED DESCRIPTION OF EXAMPLE EMBODIMENTS

The present invention relates to automatically setting a group-ride mode of a speed-control or proximity-control system of a two-wheeled motor vehicle. Such a system controls the vehicle speed, as well as the distance from the vehicle traveling ahead. The presence of a group ride is based on a classification of the vehicle traveling ahead. For example, a video or camera system reveals if the vehicle traveling ahead is a two-wheeled motor vehicle, in particular, a motorcycle, or another type of vehicle. In addition, the positioning of the vehicle traveling ahead on the roadway, in particular, its lateral offset from the two-wheeled motor vehicle, has an influence on the determination as to whether a group ride is present.

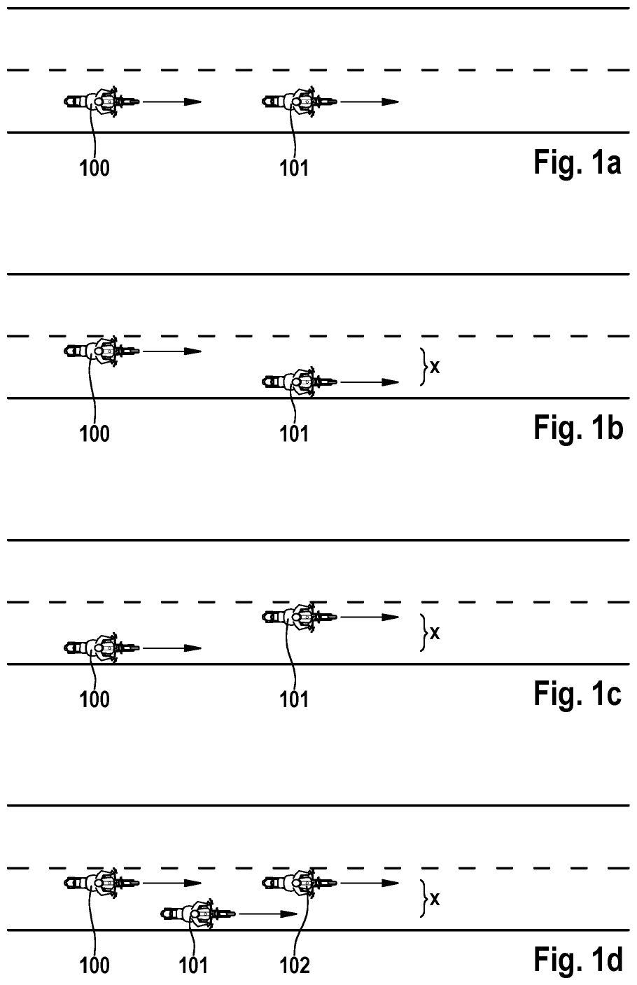

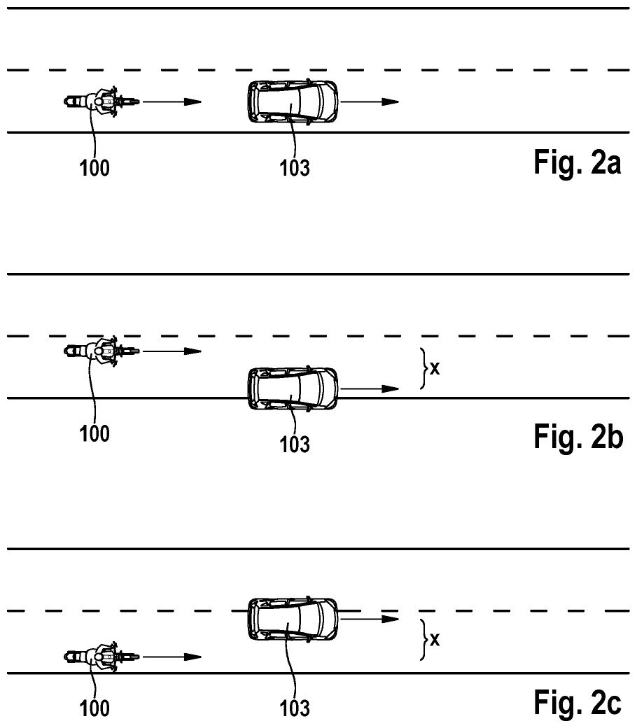

To that end, FIGS. 1a-1d and 2a-2c show, in each instance, a top view of a road, which includes a centerline, and in the right lane of which the vehicles move from left to right. Two-wheeled motor vehicle 100 includes a speed-control or proximity-control system, which may be set to a group-ride mode and, in this case, allows individual group members to ride more closely together. In FIGS. 1a-1d and in FIG. 2a-2d, the vehicle traveling ahead is a two-wheeled motor vehicle and a passenger car, respectively.

From top to bottom, FIGS. 1a-1d show 4 different scenarios, which are labeled a) through d).

In scenario 1a), vehicle 100 follows vehicle 101 traveling ahead without any considerable offset. This is the most common riding situation and is, therefore, also not recognized as a group ride.

In scenario 1b), vehicle 101 traveling ahead has a large lateral offset x to the right, and in scenario 1c), a large lateral offset x to the left. Therefore, the presence of a group ride is detected in both cases. The longitudinal distance may now be adjusted by vehicle 100 to a lower value, as there is also no risk of collision due to the considerable lateral offset.

In scenario 1d), as well, the presence of a group ride is detected as a result of the lateral offset of two-wheeled motor vehicle 101 traveling ahead. In this context, two-wheeled vehicle 102 further away from motor vehicle 100 in the longitudinal direction is not relevant.

In FIGS. 2a-2c, motor vehicle 103 traveling ahead is a passenger car in each of scenarios a) through c). Its lateral offset from two-wheeled motor vehicle 100 is very small in scenario 2a).

Scenario 2b) shows a considerable offset to the right, and scenario 2c) shows a considerable offset to the left. Since vehicle 103 traveling ahead is never a two-wheeled motor vehicle, it is concluded that in all three scenarios, a group ride is not present.

1-7. (canceled)

8. A method for automatically setting a speed-control or proximity-control system of a two-wheeled motor vehicle, comprising the following steps:
ascertaining if the two-wheeled motor vehicle is on a group ride with at least one other two-wheeled motor vehicle; and
based on ascertaining the two-wheeled motor vehicle is on a group ride, switching a speed-control system or proximity-control system a special operating mode.

9. The method as recited in claim 8, wherein a group ride is ascertained as present when presence of a vehicle traveling ahead is ascertained, the vehicle traveling ahead is a second two-wheeled motor vehicle, and the second two-wheeled motor vehicle has a lateral offset with respect to the two-wheeled motor vehicle, the lateral offset exceeding a predefined threshold value.

10. The method as recited in claim 9, wherein the lateral offset may be an offset in a direction of a right edge of a roadway or an offset in a direction of a left edge of the roadway.

11. The method as recited in claim 9, wherein the two-wheeled motor vehicle includes a video sensor system, and a determination as to whether the vehicle traveling ahead is a second two-wheeled motor vehicle is made by evaluating output signals of the video sensor system.

12. The method as recited in claim 8, wherein in the special operating mode, a shorter distance from a second two-wheeled motor vehicle is allowed.

13. The method as recited in claim 8, wherein the two-wheeled motor vehicle is a motorcycle.

14. An apparatus configured to automatically set a speed-control or proximity-control system of a two-wheeled motor vehicle, the apparatus configured to:
ascertain if the two-wheeled motor vehicle is on a group ride with at least one other two-wheeled motor vehicle; and
based on ascertaining the two-wheeled motor vehicle is on a group ride, switch a speed-control system or proximity-control system a special operating mode.
